(19) United States
(12) Patent Application Publication
(10) Pub. No.: US 2025/0194859 A1
(43) Pub. Date: Jun. 19, 2025

(54) COOKING DEVICE COMPRISING A VESSEL SENSOR CONDUIT AND METHOD FOR PRODUCING A COOKING DEVICE WITH A VESSEL SENSOR CONDUIT

(71) Applicant: Prodlog GmbH, Eschlikon (CH)

(72) Inventors: Stephan WEBER, Eschlikon (CH); Mario WEBER, Frauenfeld (CH)

(73) Assignee: Prodlog GmbH, Eschlikon (CH)

(21) Appl. No.: 18/847,882

(22) PCT Filed: Mar. 10, 2023
(86) PCT No.: PCT/EP2023/056134

§ 371 Date: Sep. 17, 2024

(30) Foreign Application Priority Data
Mar. 21, 2022 (EP) 22163276.3

(51) Int. Cl. A47J 45/06; A47J 27/00; A47J 36/02; A47J 37/10; H05B 6/06

(52) U.S. Cl. CPC A47J 45/068; A47J 27/002; A47J 36/02; A47J 37/108; A47J 45/061; H05B 6/062; A47J 2202/00

(57) ABSTRACT

The invention relates to a cooking device (1), in particular a frying pan, comprising a vessel (18). The vessel (18) comprises a multi-layered base (2) and a multi-layered side wall (3), wherein the side wall (3) is connected to the base (2) by a transition area and wherein the side wall (3) comprises a connecting arrangement (9) for connecting to a handle element (8). Furthermore, the vessel (2) comprises a vessel sensor conduit (4). The base (2) has a center area around a center point. The vessel sensor conduit (4) extends within the base (2) and the side wall (3) from the connecting arrangement (9) to the base (2), preferably substantially to the center region. The radius in the transition area is at least 19 mm.

The invention also relates to a method for producing a cooking device (1).

The present invention relates to a cooking device comprising a vessel sensor conduit and a method of producing a cooking device with a sensor conduit.

Cooking devices are devices for preparing food on a heat source such as a stove or a fire. In order to be able to control and monitor the cooking process of the food, cooking devices advantageously have a temperature sensor which is installed in the base of the cooking devices.

Cooking devices with a sensor conduit are known. WO 2019/193044 A1 discloses a method for producing and processing a plate constructed from plate bodies, which is provided with or can be retrofitted with at least one embedded temperature sensor. A sensor conduit is arranged between several plate bodies and the plate composed of several plate bodies is then further processed.

WO 2017/137833 A1 discloses a cooking device with a sensor conduit arranged in a side wall and in the base of the cooking device.

The cooking devices with a sensor conduit known from the prior art have a narrow radius between the base and the side wall. Such a radius makes it impossible to manufacture the vessel of the cooking device in one piece by forming or deep drawing without buckling the sensor conduit. No sensor can be inserted through a buckled sensor conduit. A device with a buckled sensor conduit is therefore technically unusable for the arrangement of a sensor. The cooking devices with a sensor conduit known in the prior art are therefore not manufacturable from a plate body.

It is therefore the task of the invention to overcome the disad-vantages of the prior art and, in particular, to create a cooking device and a method for producing a cooking device which can be carried out simply and safely and wherein the sensor conduit re-mains unbuckled, so that a sensor can be inserted into the sensor conduit and wherein the vessel of the device can be produced from a plate body.

The task is solved by a cooking device with a vessel sensor conduit and a method for producing a cooking device with a vessel sensor conduit according to the independent patent claims.

In particular, the task is solved by a cooking device, in particular a frying pan, comprising a vessel. The vessel comprises a multi-layer base and a multi-layer side wall. The side wall is connected to the base by a transition region. The side wall comprises a connecting arrangement for connecting to a handle element. The base of the vessel has a center region around a center point. The vessel comprises a vessel sensor conduit extending within the base and the side wall from the connection arrangement to the base. The vessel sensor conduit may extend within the base and the side wall from the connecting arrangement substantially to the center region. The radius in the transition area is at least 19 mm.

Such a cooking device can be advantageously used and manufactured. Due to the large radius in the transition area, the vessel can be produced from a single workpiece by forming, for example deep drawing, and is thus preferably produced from a single piece. This means that it is not necessary for the vessel to be assembled from several components. It is not necessary for several workpieces, such as a base part and a side wall, to be joined together. This means that at least one production step can be saved when producing the cooking device, in which the individual workpieces would have to be precisely aligned and then joined by welding, for example.

Manufacturing the vessel of the cooking device from a single workpiece saves resources and is therefore inexpensive. In addition, parts that are connected with fasteners such as rivets, screws or a weld seam are susceptible to mechanical impact. A vessel produced from a single workpiece is therefore particularly robust and in-sensitive to mechanical impact.

In the context of the invention, handle element is understood to mean any type of handle or grip.

The vessel, the base and the side wall can each be produced from two layers or three layers or more. The layers can be made of different materials. The layers can be made of aluminum, or iron, or an alloy containing iron. The layers can also be made of a different material. It is possible that the base and the side wall have a non-stick coating, for example Teflon. The vessel sensor conduit can have a circular base in cross-section. The vessel sensor conduit can also have a rectangular or square base. The vessel sensor conduit can have an oval or otherwise shaped base. The base can be essentially circular. The base may also be oval or otherwise shaped.

The base of the cooking device and the side wall of the cooking device may have at least one outer layer comprising iron or a iron alloy.

These materials allow the pan to be used on an induction hob. This enables a very fast and efficient frying and cooking process.

The outer layer of the base and the side wall can be made of stainless steel, for example. The side wall and base can also comprise iron. It is possible for the cooking device to have an inner layer made of the same material as the outer layer. It is possible that the inner layer of the cooking device is made of a different material than the outer layer. The middle layer, which is arranged between the outer layer and the inner layer, can be made of aluminum and/or copper and/or another material.

The connection arrangement of the cooking device may have a sensor opening forming the end of the vessel sensor conduit.

A sensor can be advantageously inserted into the vessel sensor conduit through such a sensor opening. The curvature with a minimum radius minimizes the friction that occurs when the sensor is inserted into the vessel sensor conduit. This results in a straightforward and simple insertion process.

The sensor opening can be circular. The sensor opening can also be rectangular, square or oval. The decisive factor is that a sensor can be inserted into the sensor opening.

The sensor opening can be at least 3 cm away from a lower edge of the base. The sensor opening of the cooking device can also be at least 5 cm from a lower edge of the base. Preferably, the sensor opening is at least 1.5 cm from the upper edge of the side wall.

Due to the distance between the sensor opening and a lower edge of the base, a handle element can be advantageously attached in the area of the sensor opening. Due to the distance of the sensor opening and thus also the handle element from a lower edge of the base, the connection between the vessel and the handle element is exposed to less high temperatures and less severe temperature fluctuations. As a result, the connection between the body and the handle element is subject to less stress and is extremely robust and durable.

The connection arrangement of the cooking device may comprise at least one centering device. The centering device can be used to connect a handle element to the side wall with a precise fit via the connection arrangement. The centering device can be conical and/or funnel-shaped.

Such a centering device allows the handle element to be quickly and accurately centered on the vessel. A person or machine can assemble the parts quickly and precisely. This results in an efficient, accurate and reproducible production process and high product quality.

The centering device can comprise pins or bolts, for example. It is conceivable that the centering device consists of one, two, three, four or more pins or bolts. The centering device can also be conical or funnel-shaped and the handle element can comprise pins or bolts. In this case, the handle element comprises pins or bolts and at least one pin or bolt of the handle element can be inserted into the centering device. Crucially, the centering device is complementary to the handle element. The centering device can be made of the same material as one of the pan layers. The centering device can also be made of a different material. Preferably, the centering device is made of a heat-resistant and cor-rosion-resistant material such as stainless steel.

The cooking device can comprise a handle element with a fastening device. The fastening device can be used to attach the handle element to the connection arrangement.

Such a fastening device allows the handle element to be quickly and accurately attached to the connection arrangement.

The fastening device can be complementary to the connection arrangement. Complementary means that the handle element with the fastening device can be centered on the connection arrangement by the centering device and can then be stably connected to the connection arrangement so that the connection can absorb high forces and torques in the connected state.

The fastening device can comprise a pin that can be inserted into the conical or cylindrical fastening device. It is also possible that the connection arrangement comprises pins or bolts, and the fastening device comprises recesses, which may be cylindrical, tapered or conical in shape. Crucially, the fastening device is complementary to the connecting arrangement. The fastening device may be made of a metal, a steel or an iron alloy. The fastening device can be made of the same material as the connecting arrangement or a layer of the vessel. The fastening device may be made of a different material. Preferably, the fastening device is made of a heat-resistant and corrosion-resistant material.

The handle element of the cooking device may have a handle element sensor channel with a handle element sensor channel opening. When the handle element is attached, the handle element sensor conduit opening is arranged to fit snugly against the body sensor conduit opening. The vessel sensor conduit and the handle element sensor conduit then form a sensor conduit.

A handle element sensor conduit allows a sensor to be advantageously inserted into the vessel sensor conduit through the handle element sensor conduit. In the manufacturing process, the filigree sensor can thus only be inserted into the sensor conduit once the handle element is already connected to the body. Manufacturing steps in which a lot of heat or a high mechanical impact occurs, for example when the body is deformed or when the handle element is connected to the body by welding, can thus be carried out without the sensor being in the sensor conduit. This ensures that the filigree sensor is not damaged during the manufacturing process. This results in a high level of product quality.

The cross-section of the handle element sensor conduit can have a circular base. The handle element sensor conduit can also have an oval, square or rectangular cross-section. The decisive factor is that a sensor can be guided through the handle element sensor conduit. The cross-section of the handle element sensor conduit opening can be shaped in the same way as the vessel sensor conduit opening. The cross-section of the handle element sensor conduit opening can also be smaller or larger than that of the vessel sensor conduit opening. Preferably, the handle element sensor conduit opening is smaller than the vessel sensor conduit opening, so that a sensor can be advantageously inserted into the vessel sensor conduit opening through the handle element sensor conduit opening. The handle element sensor conduit opening may have the same or a different shape as the vessel sensor conduit opening.

The cooking device may comprise a sensor device. The sensor device may comprise a sensor, an electrical conductor and a display device and/or communication device. The sensor may be a temperature sensor. The sensor may be arranged in the vessel sensor conduit. The sensor may be arranged in the vessel sensor conduit essentially in the center area of the base. The electrical conductor can be arranged in the sensor conduit. The display device and/or communication device may be arranged in the handle element and/or on the handle element. The sensor can be connected to the display device and/or the communication device by the electrical conductor.

The electrical conductor can be at least partially shaped as a spiral spring, in particular in an area adjacent to the display device and/or communication device.

An electrical conductor shaped in this way can compensate for tensile loads on the conductor without being pulled out of the sensor conduit.

With such a sensor, the temperature in the center of the base can be measured advantageously and food can be cooked and/or fried extremely precisely.

The display device can show one or more measured values from the sensor. For example, the display device can show the temperature. The display device and/or communication device can be arranged in the handle element or on the handle element. The display device and/or communication device can be screwed into the handle element or glued into the handle element or glued to the handle element. It is also conceivable to attach the display device and/or communication device in another way. The sensor and/or the electrical conductor can be shaped or pre-tensioned in such a way that the sensor touches the top of the sensor conduit in the center area when installed. The sensor and/or the electrical conductor can also be shaped or pre-tensioned so that the sensor touches the underside of the sensor conduit in the center area when installed. A position of the sensor in the sensor conduit in the center area in which the sensor does not touch the sensor wall is also conceivable.

The display device and/or communication device can comprise an interface. The interface can be used to connect the display device and/or communication device to a smartphone and/or computer. The interface may comprise a Bluetooth module and/or WLAN module.

With such an interface, the display device and/or communication device can advantageously be connected to a mobile end device or a suitable stove or oven. By coupling the display device and/or communication device, a measured value of the sensor, for example the temperature, can be displayed on a mobile device. It is also possible for the display device and/or communication device to both display the measured value and communicate the measured value to a mobile end device. A user of the cooking device can then monitor and control the frying or cooking process both directly at the cooking point by viewing the display and also at a distance from the cooking point by viewing the display of the mobile ter-minal to which the display device and/or communication device is connected.

The cooking device may comprise an energy storage device. The energy storage device may be, for example, an accumulator or a battery.

Such an energy storage device allows the cooking device to be operated flexibly. It is not necessary for the cooking device to be connected to the electrical current with a cable during use. A cable would possibly hinder other operations that take place in the shade of the frying and cooking process at the cooking zone. In addition, a cable could be heated by a heat source, such as a hotplate, and melt or even ignite. The energy storage device therefore means that the cooking device can be used without a cable, which is extremely safe and user-friendly.

It is possible for the energy storage device to accommodate commercially available rechargeable batteries or batteries. A rechargeable battery can also be integrated into the cooking device, which can be charged by a cable or wirelessly, in particular in-ductively. The cable can then be connected to the cooking device when it is not in use. It is also possible that the energy storage device accommodates commercially available rechargeable batteries and has a connection device. The commercially available rechargeable batteries can then be charged by connecting the cable to the connection device and connecting it to the electrical current.

The task is further solved by a method for producing a cooking device, in particular for producing a cooking device as described above. The method comprises the following steps:
Arranging a multilayer plate body comprising a vessel sensor conduit in a deforming device;
deforming, in particular deep drawing, the plate bodies by means of the deforming device;
removing the body from the cooking device.

The deformation of the plate bodies takes at least 5 s. The deformation of the plate body may also take at least 14 s or at least 16 s, depending on the height of the side wall. The deforming of the plate body may also take substantially at least 1 s per 1 cm of height, wherein the height is the distance between a lower edge of a base of the deformed plate body and an upper edge of a side wall of the deformed plate body.

Such a method is simple and safe to perform. The duration of the deformation process ensures that the vessel sensor conduit does not buckle during the deformation process. Rather, the vessel sensor conduit essentially retains its cross-section over its entire length during the deformation process.

The multi-layered plate bodies can be shaped into a cuboid before the deformation process. The multilayer plate bodies can also be shaped cylindrically before the deformation process. Preferably, the multilayer plate body has a substantially circular cylindrical shape prior to the forming process, with the height of the circular cylinder being significantly less than the radius of the circular cylinder. Forming or deep drawing can be carried out using a stamp, for example. It is possible for the stamp to move uniformly line-arly during the forming process. It is possible for the stamp to move faster in one phase of the deformation process than in another phase of the deformation process. It is possible that the stamp moves more slowly during the first 15 mm of the deformation process than during the rest of the deformation process.

It is possible that the multilayer plate bodies are provided with a lubricant during the deformation process, for example drawing oil. It is possible that the plate bodies are essentially at room temperature during the deformation process. It is also possible for the plate bodies to have a temperature of over 50° C., over 100° C. during the deformation process.

The method may comprise the following further steps:
forming a connector assembly having a centering device and a sensor opening on the side wall of the vessel; and
arranging a handle element with a fastening device and a handle element sensor opening on the centering device of the vessel, wherein the handle element with the fastening device is attached and centered on the centering device in such a way that the handle element sensor opening is arranged to fit precisely on the sensor opening;
connecting the fastening device to the connecting arrangement, wherein the fastening device is preferably connected to the connecting arrangement by welding, riveting, pressure welding, gluing and/or screwing;
inserting a sensor unit comprising a sensor, an electrical conductor and a communication device into the sensor conduit, wherein the sensor and the electrical conductor are at least partially inserted first into the handle element sensor conduit and then into the vessel sensor conduit, and preferably the vessel sensor conduit and/or the handle element sensor conduit are previously coated with a lubricant, in particular silicone spray or silicone oil;
arranging the communication device in the handle element and/or on the handle element.

Using such a method, the cooking device can be manufactured easily and efficiently. By arranging the handle element with a fastening device and a handle element sensor opening on the centering device of the vessel, it is ensured that the handle element sensor opening and the sensor opening are arranged to fit precisely. This makes the method straightforward and reproducible. By applying pressure to the vessel sensor conduit and/or the handle element sensor conduit, the friction that occurs between the sensor device and the vessel sensor conduit and/or the handle element sensor conduit when the sensor device is inserted is minimized. Since the sensor unit is only inserted after the process steps that involve high mechanical and/or thermal stress (welding, forming, riveting), it is extremely unlikely that the filigree sensor unit will be damaged during the method.

The sensor opening is preferably milled, eroded, drilled or opened by analogous methods through the outermost layer of the side wall.

The handle element sensor conduit can be drilled subsequently or already provided during handle production by inserting a tubular element.

It is possible for the lubricant to be sprayed into the vessel sensor conduit. It is possible that the lubricant is sprayed into the handle element sensor conduit. It is possible that the lubricant is sprayed onto the sensor device or that the sensor device is dipped into the lubricant. A combination of the aforementioned measures is also possible. The decisive factor is that the sensor device can be inserted into the sensor conduit easily, precisely and with as little friction and resistance as possible.

The fastening device can be connected to the connection arrangement by several of the connection types welding, riveting, pressure welding, gluing and/or screwing. Other types of fastening are also conceivable. The communication device can be inserted into the handle element. The communication device can also be screwed into the handle element. It is possible that the handle element comprises an internal thread and the communication device comprises an external thread and the communication device is then screwed into the handle element. It is also possible that the communication device is complementary to the end of the handle element and that the communication device is glued into the handle element. Other types of fastening with which the communication device is attached in the handle element or on the handle element are also conceivable.

The invention is explained in more detail in the following figures. It shows:

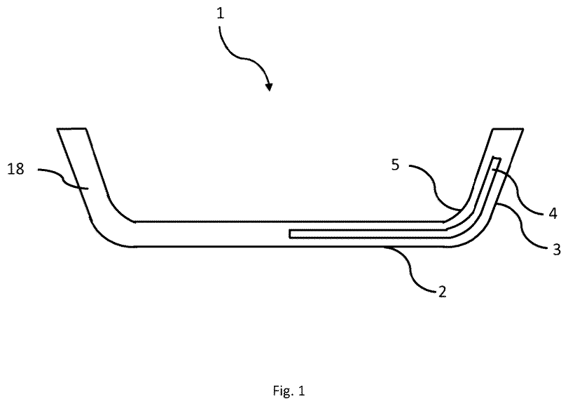

FIG. 1: A cooking device with a vessel sensor conduit;

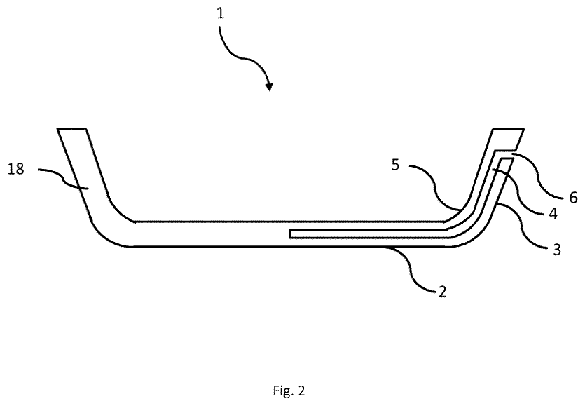

FIG. 2: A cooking device with a vessel sensor conduit and a sensor opening;

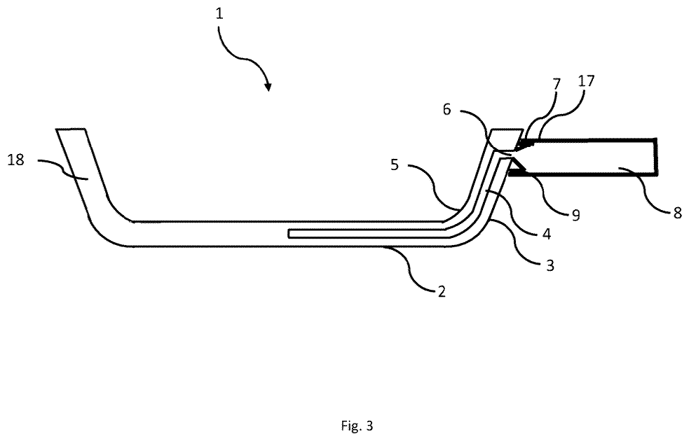

FIG. 3: A cooking device with a vessel sensor conduit and a handle element;

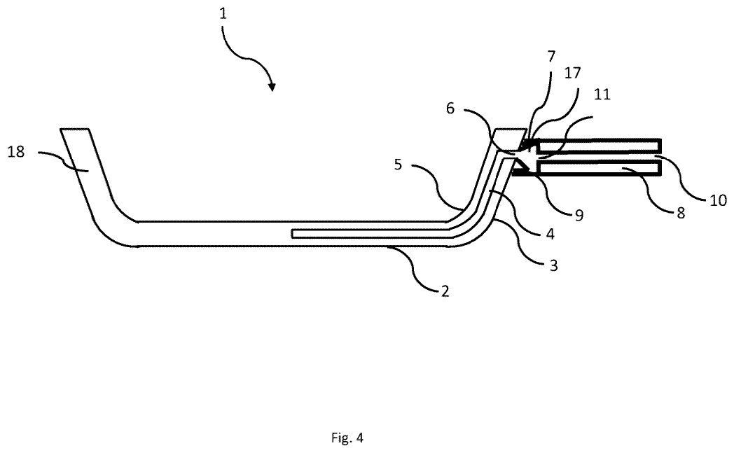

FIG. 4: A cooking device with a handle element and a sensor conduit;

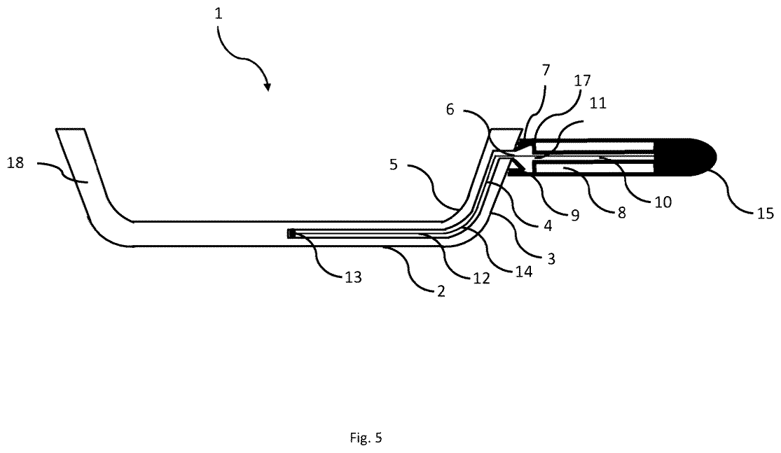

FIG. 5: A cooking device with a handle element and a display device;

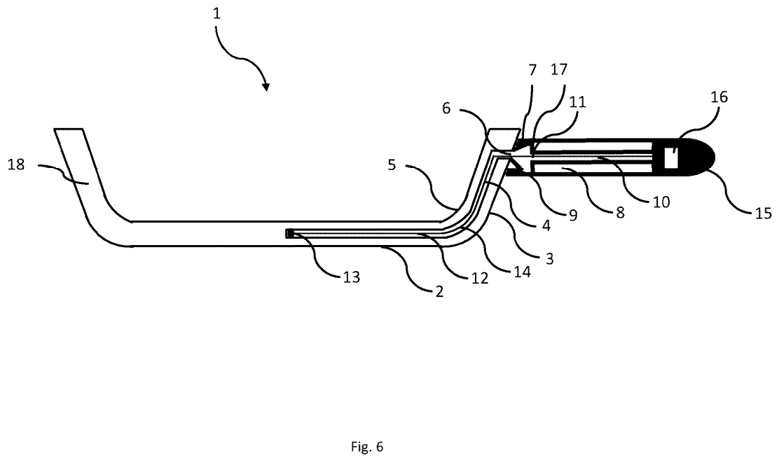

FIG. 6: A cooking device with a handle element and an energy storage device.

FIG. 1 shows a cooking device 1 with a vessel sensor conduit 4. The vessel 18 has a base 2 and a side wall 3. The base 2 is connected to the side wall 3 by a transition area 5. The transition area 5 is curved. The vessel sensor conduit 4 extends from the center area of the base 2 into the side wall 3.

FIG. 2 shows a cooking device 1. The vessel 18 has a vessel sensor conduit 4 and a sensor opening 6. The sensor opening 6 is formed on the side wall 3 of the vessel 18. The sensor opening 6 leads into the vessel sensor conduit 4. Identical reference signs denote the same components.

FIG. 3 shows a cooking device 1 with a vessel 18 and a handle element 8. The cooking device 1 comprises a centering device 7 and a connecting arrangement 9. The handle element 8 is attached to the connecting arrangement 9 and fastened to the handle element 8 with the fastening device 17. The centering device 7 is designed as a funnel. A sensor and/or electrical conductor can be inserted through the funnel-shaped centering device 7 into the vessel sensor conduit 4 through the sensor opening 6. Identical reference signs denote the same components.

FIG. 4 shows a cooking device 1 with a vessel sensor conduit 4, a handle element 8 and a handle element sensor conduit 10. The vessel sensor conduit 4 is formed in the vessel 18. The handle element sensor conduit 10 is formed in the handle element 8. The handle element 8 is attached to the connecting arrangement 9 and fastened to the handle element 8 by the fastening device 17. The centering device 7 is designed such that the handle element 8 can be centered on the centering device 7 and a sensor device 12 can be inserted into the vessel sensor conduit 4 through the handle element sensor conduit 10, the handle element sensor conduit opening 11, the centering device 7 and the sensor opening 6. Identical reference signs denote the same components.

FIG. 5 shows a cooking device 1 with a sensor device 12, a handle element 8 and a display device 15. The display device 15 is arranged on the handle element 8. The sensor device 12 comprises a sensor 13, an electrical conductor 14 and a display device 15. The sensor 13 is arranged in the center area of the base 2 of the cooking device 1. The electrical conductor 14 runs through the vessel sensor conduit 4, the sensor opening 6, the centering device 7, the handle element sensor conduit opening 11 and the handle element sensor conduit 10 to the display device 15. Identical reference signs denote the same components.

FIG. 6 shows a cooking device 1 with a sensor device 12, a display device 15 and an energy storage device 16. The energy storage device 16 is integrated into the display device 15. Identical reference signs denote the same components.

1. A cooking device comprising a vessel comprising a multi-layered base and a multi-layered side wall, wherein the side wall is connected to the base by a transition area and wherein the side wall comprises a connecting arrangement for connecting to a handle element, and a vessel sensor conduit, wherein the base has a central area around a center point, and the vessel sensor conduit extends within the base and the side wall from the connecting arrangement to the base, wherein the radius in the transition area is at least 19 mm.

2. The cooking device according to claim 1, wherein the base has at least one outer layer comprising iron or iron alloy.

3. The cooking device according to claim 1, wherein the connection arrangement comprises a sensor opening forming the end of the vessel sensor conduit.

4. The cooking device according to claim 3, wherein the sensor opening is spaced at least 3 cm from a lower edge of the base.

5. The cooking device according to claim 1, wherein the connecting arrangement comprises at least one centering device, by means of which a handle element can be connected to the side wall in a precisely fitting manner via the connecting arrangement.

6. The cooking device according to claim 1, wherein the cooking device comprises a handle element with a fastening device by means of which the handle element can be fastened to the connecting arrangement.

7. The cooking device according to claim 6, wherein the handle element has a handle element sensor conduit with a handle element sensor conduit opening, wherein in the attached state of the handle element the handle element sensor conduit opening is arranged to fit precisely at the vessel sensor conduit opening, so that a sensor conduit is formed from the vessel sensor conduit and the handle element sensor conduit.

8. The cooking device according to claim 7, wherein the cooking device has a sensor device which has a sensor, an electrical conductor and at least one of a display device and communication device, the sensor being arranged in the vessel sensor conduit, the electrical conductor being arranged in the sensor conduit and at least one of the display device and communication device being arranged in at least one of the handle element and on the handle element, and the sensor being connected to at least one of the display device and/or the communication device by the electrical conductor.

9. The cooking device according to claim 8, wherein at least one of the display device and communication device comprises an interface with which at least one of the display device and communication device can be connected to at least one of a smartphone and computer and stove and oven.

10. The cooking device according to claim 1, wherein the cooking device comprises an energy storage device.

11. A method of producing a cooking device, comprising the following steps:
arranging a multilayer plate body comprising a vessel sensor conduit in a deforming device;
deforming the plate body by means of the deforming device;
removing the vessel from the cooking device,
wherein the deformation of the plate body takes at least one of at least 5 s and in that the deformation of the plate body is at least 1 s per 1 cm height, the height being the distance between a lower edge of a base of the deformed plate body and an upper edge of a side wall of the deformed plate body.

12. The method according to claim 11, comprising the further steps of:
forming a connector assembly having a centering device and a sensor opening on the side wall of the vessel.

13. The method according to claim 12, comprising the further step of:
arranging a handle element with a fastening device and a handle element sensor opening on the centering device of the vessel, wherein the handle element with the fastening device is attached and centered on the centering device such that the handle element sensor opening is arranged to fit precisely on the sensor opening.

14. The method according to claim 13, comprising the further step of:
connecting the fastening device to the connecting arrangement.

15. The method according to claim 11, comprising the further step of:
inserting a sensor unit comprising a sensor, an electrical conductor and a communication device into the sensor conduit, wherein the sensor and the electrical conductor are at least partially inserted first into the handle element sensor conduit and then into the vessel sensor conduit.

16. The method according to claim 15, comprising the further step of:
arranging the communication device at least one of in the handle element and on the handle element.
